(19) United States
(12) Patent Application Publication
(10) Pub. No.: US 2025/0027801 A1
(43) Pub. Date: Jan. 23, 2025

(54) QUALIMETRY EVALUATED BY A FLUID METER

(71) Applicant: SAGEMCOM ENERGY & TELECOM SAS, BOIS-COLOMBES (FR)

(72) Inventor: Henri TEBOULLE, BOIS-COLOMBES (FR)

(21) Appl. No.: 18/775,527

(22) Filed: Jul. 17, 2024

(30) Foreign Application Priority Data
Jul. 19, 2023 (FR) FR2307746

(51) Int. Cl. G01F 1/667; G01N 21/53

(52) U.S. Cl. CPC G01F 1/667; G01N 21/532

(57) ABSTRACT

A fluid meter includes a conduit in which the fluid circulates, an emitter arranged to emit a light signal into the conduit, a receiver arranged to receive the light signal after this has travelled a predefined path in the conduit, and a processing unit arranged to acquire an electrical signal produced by the receiver, and to evaluate a turbidity of the fluid from said electrical signal.

The invention relates to the field of smart fluid meters.

### BACKGROUND OF THE INVENTION

The distribution of drinking water is ensured by distribution networks which comprise pipes and hydraulic devices which make it possible to optimise the circulation of water from water tanks to end user installations via pipes.

For health and safety reasons, it is essential to control the quality of drinking water.

The quality of the water distributed naturally depends on the quality of the water at the time of it being captured, the treatments that it undergoes, but also the materials with which it is in contact in the tanks and during its circulation in the distribution network. Deposition phenomena (biofilms, scaling, metal oxides, etc.) can indeed occur in tanks and pipes.

Water producers, network managers and health authorities therefore very closely and ongoingly monitor the quality of drinking water distributed.

This monitoring can however lack precision, in particular due to the extent of the distribution networks. It is, for example, possible that the quality of the water observed at end users' places located in a particular area is substantially lower than the quality evaluated upstream of said area. This can result from a localised degradation of pipes, that the monitoring devices are not capable of detecting.

It therefore seems relevant to try to improve the precision of the evaluation of the quality of the water supply according to the location in the network. It would be preferable that the cost associated with this improvement is not too significant.

### AIM OF THE INVENTION

The invention aims for a solution, making it possible, in a fluid distribution network, to improve the precision of the evaluation of the quality of the fluid supply according to the location, said solution having a limited cost.

### SUMMARY OF THE INVENTION

In view of achieving this aim, a fluid meter is proposed, comprising:
a conduit in which the fluid circulates;
an emitter arranged to emit a light signal into the conduit;
a receiver arranged to receive the light signal after this has travelled a predefined path in the conduit;
a processing unit arranged to acquire an electrical signal produced by the receiver, and to evaluate a turbidity of the fluid from said electrical signal.

The emitter and the receiver of the light signal are therefore used to evaluate the turbidity of the fluid which circulates in the conduit of the meter.

The turbidity is a relevant parameter for measuring the quality of the fluid supply. The evaluation of the turbidity is done by the meter itself and therefore at the end user's installation. The invention therefore makes it possible to obtain a measurement of the qualimetry of the fluid supply, which is associated with a very precise location in the network.

The cost of evaluating the turbidity is very reduced, as the emitter and the receiver of the light signal are inexpensive components, which are simple to integrate in the meter.

In addition, a fluid meter such as described above is proposed, in which the fluid circulates in the conduit in a first direction, and in which the predefined path extends in a second direction, perpendicular to the first direction.

In addition, a fluid meter such as described above is proposed, in which the light signal is an infrared signal.

In addition, a fluid meter such as described above is proposed, in which the emitter is a light-emitting diode and the receiver is a photodiode.

In addition, a fluid meter such as described above is proposed, in which the conduit comprises two holes, and in which the emitter and the receiver each extend at least partially through one of the holes.

In addition, a fluid meter such as described above is proposed, in which the two holes are located on the conduit at diametrically opposite positions.

In addition, a fluid meter such as described above is proposed, in which the electrical signal is an electric current, and in which the turbidity evaluated by the processing unit is inversely proportional to said electric current.

In addition, a fluid meter such as described above is proposed, further comprising an ultrasonic measuring device comprising an upstream transducer and a downstream transducer and arranged to measure a flow rate of the fluid, the emitter and the receiver being positioned downstream of the upstream transducer and of the downstream transducer.

In addition, a fluid meter such as described above is proposed, the processing unit being arranged to evaluate qualimetry parameters representative of a quality of a fluid supply, said qualimetry parameters comprising the turbidity of the fluid.

In addition, a fluid meter such as described above is proposed, the qualimetry parameters further comprising a temperature of the fluid.

In addition, a fluid meter such as described above is proposed, the processing unit being arranged to evaluate a speed of sound in the fluid by using the ultrasonic measuring device, then to evaluate the temperature of the fluid from the speed of sound.

In addition, a fluid meter such as described above is proposed, in which the meter comprises at least one pressure sensor, the qualimetry parameters further comprising a pressure measured by said pressure sensor.

In addition, a fluid meter such as described above is proposed, in which the meter comprises an upstream pressure sensor, positioned on a side of an upstream end of the conduit, and a downstream pressure sensor, positioned on a side of a downstream end of the conduit, the qualimetry parameters further comprising a pressure value representative of a pressure difference between an upstream pressure measured by the upstream pressure sensor and a downstream pressure measured by the downstream pressure sensor.

In addition, a fluid meter such as described above is proposed, further comprising a communication module, the processing unit being arranged to receive, via the communication module, a request emitted by a system external to the fluid meter, and to, in response to said request, transmit the qualimetry parameters to said system.

In addition, a measuring method is proposed, implemented in the processing unit of a fluid meter such as described above, comprising the steps of:
controlling the emitter such that it emits the light signal into the conduit;
acquiring the electrical signal produced by the receiver;
evaluating a turbidity of the fluid from said electric signal.

In addition, a computer program is proposed, comprising instructions which make the processing unit of the fluid meter such as described above execute the steps of the measuring method such as described above.

In addition, a computer-readable storage medium is proposed, on which the computer program such as described above is stored.

The invention will be better understood in the light of the following description of a particular, non-limiting embodiment of the invention.

### BRIEF DESCRIPTION OF THE DRAWINGS

Reference will be made to the accompanying drawings, among which:

FIG. 1 represents a water meter;

FIG. 2 represents a simplified and partial cross-sectional view of the conduit of the meter, along a plane passing through a longitudinal axis of the conduit.

### DETAILED DESCRIPTION OF THE INVENTION

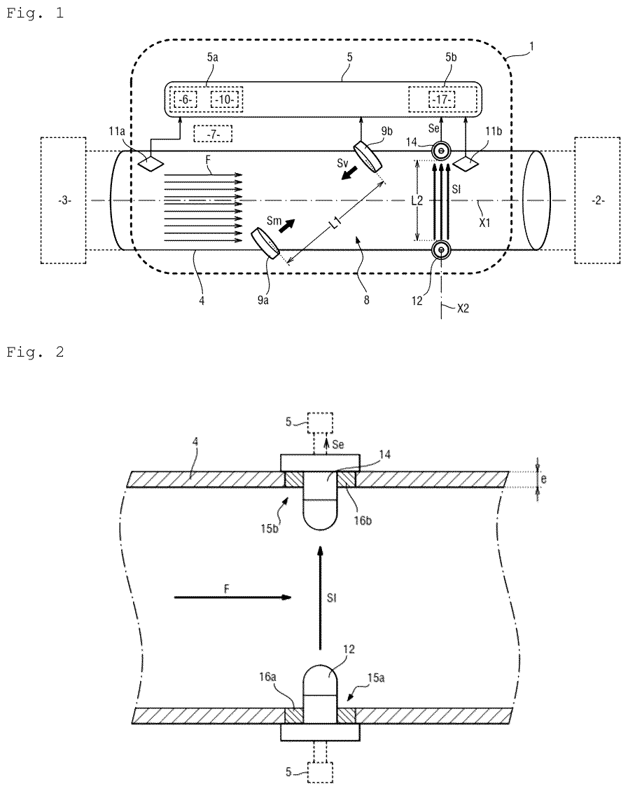

In reference to FIG. 1, the water meter 1 is used to measure the water consumption of the installation 2 of an end user. The water is supplied to the installation 2 by a water distribution network 3.

The meter 1 comprises a conduit 4 in which the water supplied by the network 3 to the installation 2 circulates. The water circulates in the conduit 4 from upstream to downstream, as indicated by the direction of the arrows F. In this case, the term “upstream” means on the side of the network 3, and the term “downstream” means on the side of the installation 2.

The meter 1 comprises a processing unit 5 (electronic and software). The processing circuit 5 comprises at least one processing component 5a which is, for example, a “general-purpose” processor, a processor specialised in signal processing (or digital signal processor (DSP)), a microcontroller, or a programmable logic circuit such as an FPGA (or field-programmable gate array) or an ASIC (or application-specific integrated circuit).

The processing circuit 5 also comprises one or more memories 5b which are connected to or integrated into the processing component 5a. At least one of these memories 5b forms a computer-readable storage medium, on which at least one computer program is stored, comprising instructions which make the processing component 5a execute at least some of the steps of the measuring method which will be described below.

In this case, the processing component 5a is the metrological microcontroller of the meter 1. The microcontroller 5a integrates an analogue-to-digital converter (ADC) 6.

The meter 1 comprises, in addition, a communication module 7. The communication module 7 implements, for example, a cellular radio connection according to the LTE-Cat M1 protocol or the NB-IoT protocol.

The meter 1 also comprises an ultrasonic measuring device 8. The ultrasonic measuring device 8 is used in order to measure the flow rate of water supplied to the installation 2 by the network 3.

The ultrasonic measuring device 8 comprises an upstream transducer 9a and a downstream transducer 9b. The ultrasonic measuring device 8 also comprises a calculation module 10 (software) which is implemented, in this case, in the microcontroller 5a of the processing unit 5. The calculation module 10 performs evaluations of the flow rate.

The upstream transducer 9a and the downstream transducer 9b are (but not necessarily) paired. In this case, the upstream transducer 9a and the downstream transducer 9b are piezoelectric transducers.

Each transducer 9a, 9b acts in succession as an emitter and a receiver of ultrasonic signals.

The processor module 5 generates an electrical excitation signal and supplies the electrical excitation signal to the emitter. The emitter then generates an ultrasonic signal. The receiver receives the ultrasonic signal after this has travelled a first predefined path in the water.

The first predefined path is, in this case, a direct path which is, in this case, inclined with respect to a longitudinal axis X1 of the conduit 4 (the first predefined path could also be parallel to said axis X1). The first predefined path could also be an indirect path: the ultrasonic signals would thus be reflected against the internal wall of the conduit 4 (optionally against reflectors themselves located on the internal wall).

The first predefined path has a first length L1, which is very precisely known.

The upstream transducer 9a and the downstream transducer 9b are in particular connected to the ADC 6 which digitises the signals produced by said transducers.

Thus, the processing unit 5 first applies the electrical excitation signal to the terminals of the upstream transducer 9a such that this generates an upstream ultrasonic signal Sm in the conduit 4. The processing unit 5 acquires a downstream electrical signal produced by the downstream transducer 9b when this receives the upstream ultrasonic signal Sm.

Then, the processing unit 5 applies the electrical excitation signal to the terminals of the downstream transducer 9b such that this generates a downstream ultrasonic signal Sv in the conduit 4. The processing unit 5 acquires an upstream electrical signal produced by the upstream transducer 9a when this receives the downstream ultrasonic signal Sv.

The calculation module 10 analyses the downstream electrical signal and the upstream electrical signal to evaluate a speed of the water in the conduit 4, then evaluates, from the speed of the water, the flow rate of the water in the conduit 4.

The meter 1 comprises, in addition, at least one pressure sensor, in this case, two pressure sensors: an upstream pressure sensor 11a, which is positioned on the side of the upstream end of the conduit 4, and a downstream pressure sensor 11b, which is positioned on the side of the downstream end of the conduit 4.

The upstream pressure sensor 11a and the downstream pressure sensor 11b are connected to the processing unit 5. The upstream pressure sensor 11a and the downstream pressure sensor 11b are, in particular, connected to the ADC 6 which digitises the measurements produced by said sensors.

The meter 1 comprises, in addition, an emitter 12 arranged to emit a light signal S1 in the conduit 4, and a receiver 14 arranged to receive the light signal S1 after this has travelled a second predefined path in the conduit 4 (and therefore in the water).

The second predefined path extends in a second direction X2 perpendicular to a first direction (axis X1) along which the water circulates.

The second predefined path has a second length L2, which is very precisely known.

The light signal S1 is, in this case, an infrared signal. The wavelength of the light signal S1 is, for example, equal to 860 nm.

The emitter 12 is, in this case, a light-emitting diode (LED) and the receiver 14 is a photodiode.

In reference to FIG. 2, a first through hole 15a and a second through hole 15b are formed in the thickness e of the wall of the conduit 4. The first hole 15a and the second hole 15a are located on the conduit 4 at diametrically opposite positions.

The LED 12 and the photodiode 14 each extend at least partially through one of the holes 15a, 15b.

The LED 12 is, in this case, encapsulated in a rounded-end cylindrically-shaped casing. The rounded end comprises, in this case, a lens. The casing is transparent or translucent to infrared light. The casing is made, in this case, of epoxy resin.

The LED 12 is inserted into the first hole 15a, such that the end of the LED 12, corresponding to the rounded end, projects inside the conduit 4.

The sealing is ensured by a first seal 16a which extends around the casing of the LED 12 by being positioned between the casing of the LED 12 and the wall of the conduit 4 at the first hole 15a.

The photodiode 14 is itself also encapsulated in a rounded-end cylindrically-shaped casing. The rounded end comprises, in this case, a lens.

The photodiode 14 is inserted into the second hole 15b, facing the LED 12, such that the end of the photodiode 14, corresponding to the rounded end, projects inside the conduit 4. The sealing is ensured by a second seal 16b which extends around the casing of the photodiode 14 by being positioned between the casing of the photodiode 14 and the wall of the conduit 4 at the second hole 15b.

The LED 12 and the photodiode 14 are connected to the processing unit 5.

The processing unit 5 can activate the LED 12 such that this emits the light signal S1, and acquire the electrical signal Se produced by the photodiode 14 when this receives the light signal S1.

The photodiode 14 is connected to the ADC 6 of the microcontroller 5 which digitises the electrical signal Se produced by the photodiode 14.

It is noted that the LED 12 and the photodiode 14 are, in this case, positioned downstream of the upstream transducer 9a and of the downstream transducer 9b of the ultrasonic measuring device 8. This makes it possible to ensure that these components do not disturb the metrological measuring of the flow rate of the water performed by the ultrasonic measuring device 8.

The processing unit 5 evaluates qualimetry parameters representative of the quality of the water supply.

The qualimetry parameters first comprise the turbidity of the water.

The processing unit 5 therefore controls the LED 12 such that this emits the light signal S1 in the conduit 4, and acquires the electrical signal Se produced by the photodiode 14. The processing unit 5 is therefore capable of determining the quantity of light received by the photodiode 14. The processing unit 5 evaluates the turbidity of the water from said electrical signal Se.

The electrical signal Se is an electric current. The turbidity evaluated by the processing unit 5 is inversely proportional to said electric current.

The turbidity is expressed in NTU (Nephelometric Turbidity Unit), which is a unit which represents an order of magnitude in mg/L of MIS (Matter In Suspension).

A calibration of the system comprising the LED 12 and the photodiode 14 integrated in the meter 1, is factory-made.

The measurements of the current are, for example, taken at a frequency of one measurement per second.

To take a turbidity measurement at the time T, the processing unit 5 takes, in this case, a predetermined number of measurements of the electrical signal Se produced by the photodiode 14 (the LED 12 being activated). The predetermined number is, for example, equal to 10, either for example 5 measurements before the time T and 5 measurements after the time T. The processing unit 5 calculates the average of these 10 current measurements to obtain an averaged current value. The processing unit 5 thus produces a turbidity measurement from the averaged current value.

The qualimetry parameters in addition comprise the temperature of the water.

The processing unit 5 evaluates a speed of sound (or velocity of sound) in the water by using the ultrasonic measuring device 8, then evaluates the temperature of the water from the speed of sound.

The ultrasonic measuring device 8 makes it possible to measure the speed c of sound, as follows.

The calculation module 10 first determines the sum of the time of flight (where ToF) of the ultrasonic signals between the two transducers 9a, 9b: sTOF.

The sum of the time of flight sTOF is therefore equal to the sum:
of the time taken by the upstream ultrasonic signal Sm to travel the first predefined path between the upstream transducer 9a and the downstream transducer 9b, and
of the time taken by the downstream ultrasonic signal Sv to travel the first predefined path between the downstream transducer 9b and the upstream transducer 9a.

The processing unit 5 thus evaluates the speed of sound by using the following formula:

$$c = \frac{2 \times L 1}{sTOF} ,$$

where L1 is the first length of the first predefined path.

Then, the processing unit 5 uses the following formula to evaluate the temperature of the water from the speed of sound:

$$c = 1.40238677 * 10 \hat{} 3 + 5.03798765 * T - 5. 80980033 * 10 \hat{} ( - 2 ) T \hat{} 2 + 3.3429665 * 10 \hat{} ( - 4 ) T \hat{} 3 - 1.47936902 * 10 \hat{} ( - 6 ) T \hat{} 4 + * 3.14893508 * 10 \hat{} ( - 9 ) T \hat{} 5$$

This equation presents a positive solution which corresponds to the temperature of the water T.

This way of evaluating the temperature of the water is very advantageous, since it does not require integrating any temperature sensor in the meter 1. The temperature of the water is evaluated by using the transducers 9a, 9b which are present in the meter 1 to take the metrology measurements. Therefore, the evaluation of a very relevant parameter to evaluate the quality of the water supply is therefore obtained without additional costs.

The qualimetry parameters further comprise a pressure measured by one of the pressure sensors of the processing unit 5.

In this case, this is the upstream pressure P_{M} measured by the upstream pressure sensor 11a.

The qualimetry parameters must verify predefined conditions in the case of a water meter to comply with the expected quality of supply. The predefined conditions are as follows:
upstream pressure P_{M}<16 Bar;
Temperature of the water T:
   Between 0.1° C. and 30° C. (for a cold water meter);
   Between 50° C. and 70° C. (for a hot water meter);
Turbidity ≤5 NTU.

The qualimetry parameters further comprise a pressure value representative of a pressure difference between an upstream pressure measured by the upstream pressure sensor 11a and a downstream pressure measured by the downstream pressure sensor 11b.

The pressure value is, in this case, equal to:

$$Δ P = {P}_{M} - {P}_{V} ,$$

where P_{M} is the upstream pressure and P_{V} is the downstream pressure.

The pressure value ΔP is the load loss due to the meter 1 itself. This is therefore not, strictly speaking, a qualimetry parameter, which is able to evaluate the quality of the water supply, but rather a constraint that the meter 1 must respect to comply with its technical and operational specifications. The flow pipe in the meter 1 necessarily leads to a slight load loss, but this must be limited.

The load loss ΔP must verify the following predefined condition:

$$Δ P < 0.63 Bar .$$

The numerical values used for the predefined conditions are programmable and can be modified according to the regulatory requirements.

The processing unit 5 creates a daily table 17 which contains the qualimetry measurements produced periodically. The period is, for example, equal to a quarter of an hour (that is 96 measurements per day).

The table 17 is stored in one of the memories 5b. An example of table 17 is provided in the appendix.

The table 17 therefore comprises 96 lines of measurements taken every quarter of an hour (for example, from 00:07:30 to 23:52:30).

To each quarter of an hour (sample), the measurements of the upstream pressure, the load loss, the temperature and the turbidity are associated.

The processing unit 5 stores, in this case, these values over one week (therefore, seven daily tables 17, identical to that provided in the appendix, including the table of the current day).

The processing unit 5 can transmit these data to a system external to the meter 1 by using the communication module 7. The processing unit 5 receives, for example, via the communication module 7, a request emitted by said system. The processing unit 5, in response to said request, transmits the qualimetry parameters to the external system via the communication module 7.

The external system is, for example, the IS (Information System) of the water distributor and/or the network manager.

The IS produces, for example, a dedicated DLMS request, to which the meter 1 responds, by sending the table 17.

The meter 1 can also emit an alarm message, to the water distributor, to the network manager, even to the end user, when the quality of the water supply is not satisfactory (i.e. that it does not fulfil the predefined conditions stated above).

Evaluating the qualimetry of the water supply by the meter makes it possible to have legal proof that the quality of the supply at the end user's place is that expected regarding temperature of the water, pressure and turbidity.

It is finally noted that, concerning electricity distribution, the qualimetry is defined in the standard NF EN 61000-4-30. To date, there is no standard relating to fluid meters, and nobody has had the idea of defining the quality of supply in the case of water, typically. However, it seems extremely relevant to have this. It is one of the aims of the present invention.

Naturally, the invention is not limited to the embodiment described, but covers any variant coming within the scope of the invention such as defined by the claims.

The meter is not necessarily a water meter, this can be a meter of any fluid: gas, oil, etc.

The LED and the photodiode do not necessarily extend through holes formed in the thickness of the conduit. The LED and the photodiode could be positioned outside of the conduit and facing these holes, which would, for example, be closed by transparent or translucent surfaces (glass, for example). The LED and the photodiode could also be fixed to the internal wall of the conduit, or integrated in a measuring device, itself integrated in the conduit.

The emitter and the receiver of the light signal are not necessarily an LED and a photodiode. This could be a laser diode and a phototransistor, for example.

The light signal is not necessarily an infrared signal, it could belong to the visible range, for example.

APPENDIX

| Types of | Upstream | ΔP (Bar) | | |
|---|---|---|---|---|
| measurements → | pressure | Load | Temperature | Turbidity |
| Samples: | (Bar) | loss | (° C.) | (NTU) |
| 1 | xxx | xxx | yyy | zzz |
| 2 | xxx | xxx | yyy | zzz |
| 3 | xxx | xxx | yyy | zzz |
| . . . | . . . | . . . | . . . | . . . |
| 95 | xxx | xxx | yyy | zzz |
| 96 | xxx | xxx | yyy | zzz |

1. A fluid meter comprising:
a conduit in which the fluid circulates;
an ultrasonic measuring device arranged to measure a flow rate of the fluid in said conduit, and comprising an upstream transducer arranged to generate an upstream ultrasonic signal in the conduit, and a downstream transducer arranged to generate a downstream ultrasonic signal in the conduit;
an emitter arranged to emit a light signal into said conduit;
a receiver arranged to receive the light signal after this has travelled a predefined path in said conduit; and
a processing unit arranged to acquire an electrical signal produced by the receiver, and to evaluate a turbidity of the fluid from said electrical signal.

2. The fluid meter according to claim 1, wherein the fluid circulates in the conduit in a first direction, and wherein the predefined path extends in a second direction, perpendicular to the first direction.

3. The fluid meter according to claim 1, wherein the light signal is an infrared signal.

4. The fluid meter according to claim 1, wherein the emitter is a light-emitting diode and the receiver is a photodiode.

5. The fluid meter according to claim 1, wherein the conduit comprises two holes, and wherein the emitter and the receiver each extend at least partially through one of the holes.

6. The fluid meter according to claim 5, wherein the two holes are located on the conduit at diametrically opposite positions.

7. The fluid meter according to claim 1, wherein the electrical signal is an electric current, and wherein the turbidity evaluated by the processing unit is inversely proportional to said electric current.

8. The fluid meter according to claim 1, the emitter and the receiver being positioned downstream of the upstream transducer and of the downstream transducer of the ultrasonic measuring device.

9. The fluid meter according to claim 1, the processing unit being arranged to evaluate qualimetry parameters representative of a quality of a fluid supply, said qualimetry parameters comprising the turbidity of the fluid.

10. The fluid meter according to claim 9, the qualimetry parameters further comprising a temperature of the fluid.

11. The fluid meter according to claim 8, the processing unit being arranged to evaluate qualimetry parameters representative of a quality of a fluid supply, said qualimetry parameters comprising the turbidity of the fluid, the processing unit being arranged to evaluate qualimetry parameters representative of a quality of a fluid supply, said qualimetry parameters comprising the turbidity of the fluid, the qualimetry parameters further comprising a temperature of the fluid and the processing unit being arranged to evaluate a speed of sound in the fluid by using the ultrasonic measuring device, then to evaluate the temperature of the fluid from the speed of sound.

12. The fluid meter according to claim 9, wherein the fluid meter further comprises at least one pressure sensor, the qualimetry parameters further comprising a pressure measured by said pressure sensor.

13. The fluid meter according to claim 12, wherein the fluid meter further comprises an upstream pressure sensor, positioned on a side of an upstream end of the conduit, and a downstream pressure sensor, positioned on a side of a downstream end of the conduit, the qualimetry parameters further comprising a pressure value representative of a pressure difference between an upstream pressure measured by the upstream pressure sensor and a downstream pressure measured by the downstream pressure sensor.

14. The fluid meter according to claim 9, further comprising a communication module, the processing unit being arranged to receive, via the communication module, a request emitted by a system external to the fluid meter, and to, in response to said request, transmit the qualimetry parameters to said system.

15. A measuring method, implemented in the processing unit of the fluid meter according to claim 1, comprising the steps of:
controlling the emitter such that it emits the light signal into the conduit;
acquiring the electrical signal produced by the receiver; and
evaluating a turbidity of the fluid from said electrical signal.

16. (canceled)

17. A non-transitory computer-readable storage medium, on which a computer program comprising instructions which make a processing unit of a fluid meter execute the steps of the measuring method according to claim 15 is stored.
